(19) United States
(12) Patent Application Publication
(10) Pub. No.: US 2014/0281703 A1
(43) Pub. Date: Sep. 18, 2014

(54) Local Repair Signature Handling for Repairable Memories

(71) Applicant: LSI CORPORATION, San Jose, CA (US)

(72) Inventors: Ramesh C. Tekumalla, Breinigsville, PA (US); Prakash Krishnamoorthy, Bethlehem, PA (US)

(73) Assignee: LSI Corporation, San Jose, CA (US)

(21) Appl. No.: 13/859,507

(22) Filed: Apr. 9, 2013

Related U.S. Application Data
(60) Provisional application No. 61/778,669, filed on Mar. 13, 2013.

(51) Int. Cl. G06F 11/10

(52) U.S. Cl. CPC G06F 11/10
USPC 714/15

(57) ABSTRACT

A method is disclosed for independent repair signature load into a repairable memory within a chip set of a design without halting operation of other repairable memories within the design. At initial power up, the repair signature is received from nonvolatile memory and parallelly stored within a memory repair register and within a local memory repair shadow register. During intermediate power ups after an operational power savings scheme shut down, the method avoids serially re-loading the signature from the nonvolatile memory and loads the repair signature from the local memory repair shadow register. During local repair signature loading, the method disables the chip select for the memory to prevent memory operations until the repair signature is fully loaded.

### CROSS REFERENCE TO RELATED APPLICATIONS

The present application claims the benefit under 35 U.S.C. §119(e) of U.S. Provisional Application Ser. No. 61/778,669, entitled “Local Repair Signature Handling for Repairable Memories,” filed Mar. 13, 2013, which is incorporated herein by reference in its entirety.

### FIELD OF THE INVENTION

The present invention relates generally to repair mechanisms to overcome manufacturing defects in memory systems. More particularly, embodiments of the present invention relate to local repair signature loading of a repairable memory.

### BACKGROUND

Memory systems have a repair mechanism to overcome manufacturing defects. Spare rows and columns are provided inside the memories so faulty elements can be bypassed in favor of operable spare elements after testing. Traditionally, in order to ensure the faulty elements are bypassed, a repair signature is serially loaded from nonvolatile memory into each memory repair register during power up. In modern designs, not all memories are active at the same time and some can be shutdown to conserve power. The complexities involved with routinely serially loading the repair signature from the nonvolatile memory can halt operation of running memories and slow startup operation causing increased power and time used to regain repowered memories. Therefore, a need remains to efficiently load the repair signature to overcome slow startup operations and power drains on each memory system.

### SUMMARY

Embodiments of the present invention overcome these complexities by loading the signature for a memory locally and as needed. In one embodiment of the present invention, a method for independent repair signature load into at least one repairable memory within a chip set of a design comprises storing a repair signature for at least one repairable memory within a memory repair register and within a memory repair shadow register, the storing occurring during an initial power on of the at least one repairable memory, the memory repair shadow register housed in an always on power domain of the design, loading the repair signature into the at least one repairable memory from the memory repair register, monitoring a power state of the at least one repairable memory, determining if the power state of the at least one repairable memory transitions from a power off state to a power on state, disabling a chip select for the at least one repairable memory if the determining results in a transition from the power off state to the power on state, loading the repair signature into the memory repair register for the at least one repairable memory from the memory repair shadow register if the determining results in a transition from the power off state to the power on state, the loading requiring no operational halt to another of the at least one repairable memory in the design, asserting a last signal when the repair signature from the from the memory repair shadow register has been loaded into the memory repair register for the at least one repairable memory, and enabling the chip select for the at least one repairable memory when the last signal is asserted.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

Other embodiments of the invention will become apparent to those skilled in the art by reference to the accompanying figures in which:

FIG. 1 is a block diagram of an exemplary repairable memory system in accordance with an embodiment of the present invention;

FIG. 2 is a flowchart of exemplary logic architecture for memory repair programming in accordance with an embodiment of the present invention;

FIG. 3 is a detailed flowchart of an exemplary Memory Repair State Machine in accordance with an embodiment of the present invention;

FIG. 4 is an exemplary flowchart of a Master State Machine to track an initial programming sequence in accordance with an embodiment of the present invention;

FIGS. 5A and 5B are exemplary logic diagrams detailing EN2 and PROG signals in accordance with an embodiment of the present invention;

FIG. 6 is a logic diagram of exemplary inputs to begin programming operation for repairable memories in accordance with an embodiment of the present invention;

FIG. 7 is an exemplary timing diagram of a Memory Repair Register in accordance with an embodiment of the present invention;

FIG. 8 is an exemplary programming timing diagram in accordance with an embodiment of the present invention; and

FIG. 9 is a flowchart of a method for local repair signature handling for repairable memories in accordance with an embodiment of the present invention.

### DETAILED DESCRIPTION

Reference will now be made in detail to the embodiments of the invention, examples of which are illustrated in the accompanying drawings.

The following description presents certain specific embodiments of the present invention. However, the present invention may be embodied in a multitude of different ways as defined and covered by the claims. In this description, reference is made to the drawings wherein like parts are designated with like numerals throughout.

Embodiments of the present invention shift a repair signature, after an intermediate memory shut down and power on, from a local register base of each individual memory device during normal operation. During an initial system power-on, the method parallelly loads the repair signature from the nonvolatile memory source (e.g., a fuse box) into the memory repair register as well as to an associated register outside each of the memories. During normal operation as part of the power savings scheme, individual memories are shut down. Embodiments of the present invention avoid re-loading the signature from the cumbersome nonvolatile memory source a second time at individual memory startup by enabling a memory specific local register to make available to the memory, the repair signature for future use. Additionally, the methods herein employ memory restart features which prevent individual memory operations until the signature is fully loaded from the local memory repair register.

Embodiments of the present invention also avoid a cumbersome system reset and halt to operation, which would normally be required to serially load the repair signature from the nonvolatile memory source to each memory within the design. Embodiments of the present invention also simplify the repair signature implementation by separating the signature load operations between power on and memory shutdown phases.

Embodiments of the present invention directly apply to Hard Disk Drives (HDD) and Tape Storage Peripherals (e.g. controllers, preamps and interfaces) but also directly apply to other types of memory devices which benefit from a repair signature.

Referring to FIG. 1, a block diagram of an exemplary repairable memory system in accordance with an embodiment of the present invention is shown. A repairable memory cell 110 comprises a memory 112, repair logic 114 and a memory repair register (MRR) 120 which holds the signature 128 for memory repair. Within the MRR 120 DATA_IN 142 flows from left to right through Most Significant Bit 122 (MSB) to the Least Significant Bit (LSB) 130 to DATA_OUT 150. As a repairable memory cell is powered on, the MRR 120 is programmed by transferring the memory repair signature to the MRR 120 via DATA_IN 142.

During traditional repair signature programming, the MRR 120 of all memories in the design are wired together to load the signature in a serial fashion. For example, if there are three repairable memory cells 110 in a traditional design with an 8 bit MRR 120 each, then each of these three MRR's 120 will be configured to shift in a 24-bit signature 128 in a serial fashion. This serial flow from left to right requires each memory in the design to undesirably halt operation while the serial loading takes place.

Traditionally, during the course of normal operation, repairable memory 110 cells are frequently shutdown to reduce power consumption while other repairable memory cells 110 of the design remain operational. When these shutdown repairable memory cells 110 are powered back on, the MRR's 120 are reprogrammed with the signature 128 for proper memory operation after each power on cycle.

Embodiments of the present invention provide clocked MRR 120 using CLOCK 144 and RESET 140 as an asynchronous active low reset. DATA_IN 142 port to MSB 122 is the data source for the MRR 120 while data in the LSB 130 position of the MRR 120 emerges at the DATA_OUT 150 port during a CLOCK 144 cycle. DATA_OUT 150 is useable to shift data into an adjacent repairable memory cell (not pictured) register in a serial fashion, with the LSB 130 value shifted into the MSB 122 of the adjacent repairable memory cell.

Referring to FIG. 2, a flowchart of exemplary logic architecture for memory repair programming in accordance with an embodiment of the present invention is shown. Embodiments of the present invention provide a method and system to store memory repair signatures 128 not only in the MRR 120, but also within an additional local Memory Repair Shadow Register (MRSR) 220. the MRSR 220 is available to reprogram each individual MRR 120 making the memory 112 operational without halting other memories within the design. Embodiments herein provide a mechanism for loading each individual memory's repair signature 128 in parallel, allowing an efficient system bring up.

Embodiments of the present invention employ a controller to provide a plurality of inputs 240 to enable the logic flow progression of architecture 200.

Embodiments of the present invention load, in parallel, each individual repair signature 128 to each individual MRR 120 within the design. Architecture 200 employs the MRSR 220, two clock gating latches 230 (one each for controlling the clock for the MRR 120 and MRSR 220) and a memory repair state machine (FIG. 3) to control the timing of data transfer from MRSR 220 to MRR 120.

Architecture 200 provides the clocked MRR 120 using a CLK1 input derived from CLK_IN 144. The logic path is enabled using the control signals EN1_A 202 and EN2 204. EN1_A 202 is active when architecture 200 directs the signature to be transferred from the MRSR 220 to the MRR 120. EN2 204 is active when methods herein command an initial program of the MRR 120 from the nonvolatile memory through D_EXT 208 (or external interface (e.g. fuse box)).

### Three Options for DATA_IN D1 142

The MSB 122 data input DATA_IN D1 142 to the MRR 120 is configured to input one of:
1) a fixed value of 1 (1′b1 210),
2) the contents of the LSB 130 from the MRSR 220 or
3) D_EXT 208 value which is data fed externally from a nonvolatile memory (or external interface).

Architecture 200 controls MUXes 250, 252, and 254 by select inputs SEL1 212 and SEL2 214 allowing the appropriate data to be channeled to D1 142. In a similar fashion, architecture 200 clocks MRSR 220 using CLK2 input derived from CLK_IN 144 enabled using the control signals EN1_B 206 and EN2 204. Architecture 200 also configures MRSR 220 to function as a barrel shift register with its LSB 130 fed back as input to its MSB 122 (D2) through MUX 254. Mux 252 and 254 via SEL1 212 serves to either circuitously shift the contents of MRSR 220 or accept new data fed through D_EXT 208. Architecture 200 exercises further control of the logic flow through RST1 140 and RST2 218 to allow for reset commands (below).

First Load of Data into MRR 120

Embodiments of the present invention command, as the device is powered on for the first time, a shifting of the memory repair signatures 128 from D_EXT 208 into the MRR 120 and MRSR 220 in a serial fashion. Architecture 200 clocks both registers by setting EN2 204 to 1, MUX 250 select signal SEL2 214 to 0, MUX 252 select signal SEL1 212 to 0 and MUX 254 select signal SEL1 212 to 0. Both the MRR 120 and MRSR 220 registers store and hold the intended memory repair signature value at the end of this initial programming process.

Once programmed, the MRSR 220 maintains a copy of the repair signature 128 programmed into MRR 120 for each repairable memory 112. The MRSR 220 is placed in an “always ON” power domain of the chip (e.g., the portion of logic that remains powered on when non-essential parts (e.g. memories) of the device are powered off to save energy). As methods herein detect an individual memory cell 110 is powered down to eventually be powered back on from a power off status, embodiments also command the programming process of the MRR 120 from the MRSR 220.

Referring to FIG. 3, a detailed flowchart of an exemplary Memory Repair State Machine in accordance with an embodiment of the present invention is shown.

Embodiments of the present invention employ method 300 including a Memory Repair State Machine (MRSM) 330 to control repair signature loading of all repairable memories in the design. As referenced herein, method 300 and MRSM 330 may be used synonymously and reference the state transitions of FIG. 3. States of method 300 MRSM 330 are IDLE 302, RESET 1 304, TEST 306, RESET2 308, PRE-LOAD 310, LOAD 312, LAST 314, and DONE 316. Each state of MRSM 330 is commanded by method 300 by assertion of at least six of the inputs 240. One embodiment of the present invention employs six of the inputs 240 to accomplish parallel programming of the MRR 120. These six signals include SEL1 212, SEL2 214, EN1_A 202, EN1_B 206, LAST 216, and RST2 218.

An overview of the method 300 process of programming the MRR 120 is accomplished in two steps: 1) in the first step, method 300 determines whether the memory 110 has been powered on by writing a series of ones in a test sequence to the MRR 120 and waiting for this pattern to successfully shift out through DATA_OUT 150. Once it is established that the memory 110 is powered on properly, 2) in the second step, method 300 resets the MRR 120 and programs it with the correct memory repair signature 128. Method 300 uses the following eight exemplary MRSM 330 states to accomplish the local programming of the repair signature 128.

### IDLE 302

At IDLE state 302, all control for both MRR 120 and MRSR 220 registers is relinquished and the MRSM 330 is not in operation. In the IDLE state 302, all inputs 240 are in an inactive state of zero (with the exception of RST2=1) and the MRSM 330 is awaiting commands from the controller to begin operation. MRSM 330 moves from IDLE 302 to RESET1 304 with assertion of the programming (PROG) signal 332. Method 300 commands RST2 218 to 1 for a single clock cycle to begin the parallel programming process.

### RESET1 304

Method 300 activates the MRSM 330 to the RESET1 304 state through assertion of the PROG signal 332. The RESET1 304 state is asserted for one clock cycle to complete the reset of the MRR 120 and make it ready for programming. When method 300 asserts the PROG command 332, the MRSM 330 triggers a global reset signal (RST2 218) for the MRR 120 associated with the memory 110. The global RST2 signal 218 resets all the bits of the MRR 120 to 0 and triggers the memory repair reprogram TEST 306 sequence. Method 300 asserts the reset signal for the MRR 120 for one clock cycle before the MRSM 330 moves to the TEST 306 state.

### TEST 306

The TEST 306 state is functional to determine whether the memory 110 has been commanded to a power on state from a power off state and is therefore in need of a repair signature programming. In the TEST 306 state, the Mux selects SEL1 212 and SEL2 214 are each set to 1 to load a logic-1 into the MRR 120 serial input D1 142. The MRR 120 clock is enabled by setting EN1_A 202 to a logic-1. For a positive edge of clock 144, a logic-1 is shifted into the MRR 120 until a logic-1 emerges from the least significant bit (LSB 130) position of MRR 120. Until this occurs, the MRSM 330 remains in the TEST 306 state. If the memory 110 is powered on properly, the LSB 130 of the MRR 120 becomes a logic-1 when the entire pattern has been shifted from the MSB 122 to the LSB 130 position. Once this logic-1 emerges from the LSB 130 position, it indicates that the memory 110 has been powered on properly and the MRSM 330 shifts to the RESET2 state 308 at the next clock cycle.

### RESET2 308

In the RESET2 state 308, the global reset signal RST2 218 is asserted again for one clock cycle to clear the contents of the MRR 120 and prepare the MRR 120 for loading the repair signature from the MRSR 220. After the single clock cycle, the MRSM 330 shifts to the PRE-LOAD 310 state.

### PRE-LOAD 310

Method 300 commands the MRSM 330 to the next state of PRE-LOAD 310. In the PRE-LOAD 310 state, the SEL1 212 signal is asserted allowing the MUXes to feed in the MRSR 220 value for reprogramming from the MRSR 220 instead of receiving data from the external input D_EXT 208. In the PRE-LOAD 310 state, MRSM 330 enables SEL2 214 to feed a 1 to the MRR 120. The MRR 120 is clocked by asserting EN1_A 202 to clock in a 1 into the MSB 122 of MRR 120. In the PRE-LOAD 310 state, the clock is disabled for the MRSR 220 so the MRSR 220 holds its value. The 1 is shifted into the MRR 120 to serve as a count for the number of clocks for which both the MRR 120 and MRSR 220 should be clocked to completely transfer the contents of the MRSR 220 into the MRR 120. When a 1 emerges at the LSB 130 position of MRR 120, it indicates that one an additional clock cycle elapse to complete the transfer of the contents of MRSR 220 into MRR 120. In the next clock cycle, method 300 commands MRSM 330 to move into the LOAD 312 state.

### LOAD 312

In the LOAD 312 state, both EN1_A 202 and EN1_B 206 are set to 1, enabling the clocking of both MRR 120 and MRSR 220. SEL1 212 remains a 1 and SEL2 214 is set to a 0, enabling the data shifted out of the LSB 130 of MRSR 220 to be fed into the MSB 122 position of both MRR 120 and MRSR 220. In the LOAD 312 state, the contents of the MRSR 220 are shifted back into the MRR 120 and MRSR 220, at the MSB 122 position, one bit at a time. The MRSM 330 remains in the LOAD 312 state until the MSB 122 of the MRR 120 is a 1 at which time, the MRSM 330 transitions to the LAST 314 state.

### LAST 314

In the LAST 314 state, both EN1_A 202 and EN1_B 206 are disabled allowing no more data shift to occur. In addition, method 300 sets the LAST signal 216 for this memory to a 1, signaling that the memory repair signature 128 has been transferred from the MRSR 220 to the MRR 120. MRSM 330 transitions to the DONE 316 state as method 300 deasserts the SEL1 212 signal.

### DONE 316

In the DONE 316 state, the MRSM 330 has finished programming the selected memory 110 and is waiting for method 300 assertion of one of two signals to again begin operation.

Once method 300 determines a negative POWER 320 signal (a memory 110 is powered down, POWER is deasserted) or if method 300 asserts the EN2 204 signal, MRSM 330 transitions back to the IDLE 302 state awaiting the PROG 332 signal. POWER 320 signal is asserted as a local memory 110 is powered. Method 300 senses a power down state of the local memory 110 and drives the POWER signal to a 0 at local memory 110 power down.

Each repairable memory 110 has its individual set of MRSR 220, MRSM 330, and LAST signals 216. When method 300 determines that each of the memories has been programmed from its MRSR 220 to MRR 120, method 300 will assert the memory's LAST signal 216. The MRSM 330 then will transition back to the DONE 316 state. Method 300 will assert the LAST signal 216 for one clock cycle to indicate the MRR 120 has been successfully programmed from the MRSM 330. After a single clock cycle, the MRSM transitions into the DONE 316 state where the LAST signal 216 remains asserted indicating successful memory 110 reprogramming. The LAST signal 216 also serves as a flag to indicate that the repair signature 128 has been successfully loaded into the MRR 120.

Referring to FIG. 4, an exemplary flowchart of a Master State Machine to track an initial programming sequence in accordance with an embodiment of the present invention is shown. Master State Machine (MSM) 400 operates to aid initial programming sequence of MRR 120.

MSM 400 maintains two states: MASTER_IDLE 420 and MASTER_PROG 422. Method 300 transitions MSM 400 from one state to the next using at least two signals: a first transition signal is the negative POWER 320 signal as sensed by method 300 from the local memory 110 indicating a power down of the memory 110. The second transition signal is the deassertion of EN2 204 (EN2_DEAS in FIG. 4). A transition from MASTER_IDLE 420 to MASTER_PROG 422 is commanded by method 300 deassertion of the EN2 204 signal. A transition from MASTER_PROG to MASTER_IDLE 420 is commanded by one of: 1) method 300 assertion of the EN2 204 signal (1′b1) indicating an initial memory 110 register programming sequence is initiated, or 2) a sensed negative POWER 320 indication from a memory 110.

A method 300 assertion of a MASTER_DONE 222 signal indicates to the MSM 400 a change of state from MASTER_IDLE 420 to MASTER_PROG and vice versa.

In operation, on a local memory 110 power on event, the MSM 400 is in MASTER_IDLE 420 state. When method 300 asserts EN2 204 signal (1′b1) to program the memory 110, the MSM 400 remains in MASTER_IDLE 420 until method 300 deasserts EN2 204 signal as indicated by EN2_DEAS 204. When method 300 deasserts EN2_DEAS 204, MSM 400 transitions to MASTER_PROG state indicating that the memory 110 is ready for normal operation. The memory 110 operation ready status is specified by the MASTER_DONE 222 signal.

When the memory 110 is initially programmed, the MSM 400 is in MASTER_PROG 422 state and MASTER_DONE 222=1. When a local memory 110 POWER goes down (POWER 320 deasserted), the MSM moves to MASTER_IDLE 420 and MASTER_DONE=0. At the same time, the method 300 sensing of a POWER 320 down will send the MRSM 330 (FIG. 3) to an IDLE 302 state as well. At this point, LAST 216 signal=0 and MASTER_DONE 222 signal=0. This disables all memory operations as method 300 uses the logical OR of MASTER_DONE 222 and LAST signal 216 to enable the memory signals. Then, as the POWER is restored, the MSM 400 remains in MASTER_IDLE 420 as EN2 204 has been 1 (asserted) during the time. MASTER_IDLE 420 to MASTER_PROG transition happens when method 300 commands EN2 from 1 to 0. As method 300 commands the DONE 316 state, the LAST signal 126 is a 1 from LAST 314 state and remains a 1 in DONE 316 state.

Referring to FIGS. 5A and 5B, each show an exemplary logic diagrams detailing EN2 and PROG signals in accordance with an embodiment of the present invention. Architecture 500 receives inputs and uses logical Boolean gates to flip flop the inputs for desired output. In FIG. 5A, architecture 500 receives CLK_IN 144 and EN2 204 to determine the deassertion of EN2 204 for negative Q1 and positive Q2 values.

In FIG. 5B architecture 500 receives POWER 320 and CLK_IN 144 to determine proper timing of the PROG 332 signal for positive Q3 and negative Q4 values.

Referring to FIG. 6, a logic diagram of exemplary inputs to begin programming operation for repairable memories in accordance with an embodiment of the present invention is shown. Architecture 600 receives input including MASTER_DONE 222 and LAST signal 216 to determine qualified enabling of memory input signals.

ENABLE_QUAL 608 is an enable signal qualifier that qualifies the signals going into the memory. The ENABLE_QUAL 608 is used to qualify the chip select (CHIP_SEL_IN 602), write enable (WRITE_EN_IN 604) and read enable (READ_EN_IN 606). These chip select, write and read signals are ANDed with the ENABLE_QUAL 608 signal to generate the final versions of chip select, write enable and read enable respectively that method 300 employs to control memory read and writes. FIG. 6 inputs and outputs are defined as
a. CHIP_SEL_IN 602 Memory chip select signal before applying method 300;
b. WRITE_EN_IN 604 Memory write enable signal before applying method 300;
c. READ_EN_IN 606 Memory read enable signal before applying method 300;
d. CHIP_SEL_OUT 610 Memory chip select signal that method generates to control the memory;
e. WRITE_EN_OUT 612 Memory write enable signal that method 300 generates to control the memory;
f. READ_EN_OUT 614 Memory read enable signal that method 300 generates to control the memory.

Referring to FIG. 7, an exemplary timing diagram of a Memory Repair Register in accordance with an embodiment of the present invention is shown. As method 300 asserts the PROG signal 332 for one clock cycle, the MRSM 330 transitions into the RESET1 304 state thereby resetting the contents of MRR 120 to 5′b00000. In the next clock cycle, the MRSM 330 transitions into the TEST 306 state. In the TEST 306 state, method 300 enables MRR 120 clock by asserting EN1_A 202 and begins to command a one bit pattern fed into the input of MRR 120 by setting the mux select SEL2 214 to a 1. This loads in a 1 when the positive edge of CLK_IN 144 arrives. The MRSM 330 remains in this state until a logic-1 emerges from the LSB 130 of the MRR 120. When the LSB 130 of the MRR 120 is a logic-1, it indicates that the memory 110 has been powered up and working properly.

Method 300 then commands MRSM 330 to transition to the second reset state RESET2 308. In the RESET2 state 308, method 300 de-asserts all enable signals and asserts the MRR 120 reset signal RST2 for one clock cycle. Method 300 commands the MRSM 330 to transition to the PRE-LOAD 310 state. The PRE-LOAD 310 state is similar to the TEST 306 state with the exception that the MRSM 330 remains in this state for a single clock cycle. In the PRE-LOAD 310 state, method 300 commands the MSB 122 of the MRR 120 to be loaded with a logic-1 before it commands the MRSM 330 to transition to the LOAD state 312.

Referring to FIG. 8, an exemplary programming timing diagram in accordance with an embodiment of the present invention is shown. In FIG. 8, the TEST 306, RESET2 308, and PRE-LOAD 310 states overlap with those of FIG. 7 and are a continuation of the MRSM 330 steps commanded by method 300. In the LOAD 312 state, method 300 sets SEL2 214 to 0, asserts both EN1_A 202 and EN1_B 206 and sets SEL1 212 to a 1. With these settings, method 300 commands the contents of MRSR 220 to shift in a ring counter fashion, pushing in the contents of the LSB 130 of MRSR 220 into both MRR 120 and MRSR 220 at the MSB 122 position. Method 300 shifts the contents of the exemplary four LSB 130 of MRSR 220 back into both the MRSR 220 and MRR 120 until the LSB 130 of MRR 120 is a 1.

As method 300 determines the LSB of MRR 120 is 1, it commands the MRSM 330 to transition to the LAST 314 state. Before this transition, the original contents of MRSR 220 have been shifted into both MRR 120 and MRSR 220. Method 300 asserts the LAST signal 216 commanding the MRSM 330 to return to the DONE 316 state indicating the MRR 120 has been programmed with the appropriate repair signature 128. In DONE 316 state, all control for both MRR 120 and MRSR 220 registers is relinquished. The memory 110 is now ready for functional operation.

### Memory Transaction Protection During Repair Register Programming

Architecture 200, in concert with methods 300, 400, 500 and 600 work together to control the control signals for memories that are reprogrammed. When MASTER_DONE=0 and LAST=0, it is an indication that the memory is undergoing either primary MRR 120 programming using EN2 204 or subsequent memory reprogramming through MRSM 330. During this programming sequence, ENABLE_QUAL 608 remains deasserted thereby effectively blocking all memory transactions from occurring. For example, if there are 5 memories in a design, methods 300 through 600 may command each individual memory 110 be individually powered down and repaired without having to program the other repairable memories in the design, thus making the repair programming available to each individual memory 110 on an as needed basis.

Referring to FIG. 9, a flowchart of a method for local repair signature handling for repairable memories in accordance with an embodiment of the present invention is shown. The method comprises, at step 902, with storing a repair signature for at least one repairable memory within a memory repair register and within a memory repair shadow register, the storing occurring during an initial power on of the at least one repairable memory, the memory repair shadow register housed in an always on power domain of the design, and at step 904, loading the repair signature into the at least one repairable memory from the memory repair register, at step 906, monitoring a power state of the at least one repairable memory, and at step 908, determining if the power state of the at least one repairable memory transitions from a power off state to a power on state. Method 900 continues at step 910 with disabling a chip select for the at least one repairable memory if the determining results in a transition from the power off state to the power on state, and at step 912, loading the repair signature into the memory repair register for the at least one repairable memory from the memory repair shadow register if the determining results in a transition from the power off state to the power on state, the loading requiring no operational halt to another of the at least one repairable memory in the design, and at step 914, asserting a last signal when the repair signature from the from the memory repair shadow register has been loaded into the memory repair register for the at least one repairable memory, and finally at step 916, enabling the chip select for the at least one repairable memory when the last signal is asserted.

### CONCLUSION

Specific blocks, sections, devices, functions, processes and modules may have been set forth. However, a skilled technologist will realize that there may be many ways to partition the method and system, and that there may be many parts, components, processes, modules or functions that may be substituted for those listed above.

While the above detailed description has shown, described and pointed out the fundamental novel features of the invention as applied to various embodiments, it will be understood that various omissions and substitutions and changes in the form and details of the method and system illustrated may be made by those skilled in the art, without departing from the intent of the invention. The foregoing description details certain embodiments of the invention. It will be appreciated, however, that no matter how detailed the foregoing appears, the invention may be embodied in other specific forms without departing from its spirit or characteristics. The described embodiment is to be considered in all respects only as illustrative and not restrictive and the scope of the invention is, therefore, indicated by the appended claims rather than by the foregoing description. All changes which come within the meaning and range of equivalency of the claims may be to be embraced within their scope.

In the present disclosure, the methods disclosed may be implemented as sets of instructions or software readable by a device. Further, it is understood that the specific order or hierarchy of steps in the methods disclosed may be examples of exemplary approaches. Based upon design preferences, it is understood that the specific order or hierarchy of steps in the method can be rearranged while remaining within the disclosed subject matter. The accompanying claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for independent repair signature load into at least one repairable memory within a chip set of a design, comprising:
storing a repair signature for at least one repairable memory within a memory repair register and within a memory repair shadow register, the storing occurring during an initial power on of the at least one repairable memory, the memory repair shadow register housed in an always on power domain of the design;
loading the repair signature into the at least one repairable memory from the memory repair register;
monitoring a power state of the at least one repairable memory;
determining if the power state of the at least one repairable memory transitions from a power off state to a power on state;
disabling a chip select for the at least one repairable memory if the determining results in a transition from the power off state to the power on state;
loading the repair signature into the memory repair register for the at least one repairable memory from the memory repair shadow register if the determining results in a transition from the power off state to the power on state, the loading requiring no operational halt to another of the at least one repairable memory in the design;
asserting a last signal when the repair signature from the from the memory repair shadow register has been loaded into the memory repair register for the at least one repairable memory; and
enabling the chip select for the at least one repairable memory when the last signal is asserted.

2. The method for independent repair signature load of claim 1, wherein storing a repair signature for at least one repairable memory within a memory repair register and within a memory repair shadow register further comprises a design of mux selects configured to 1) receive a repair signature from a nonvolatile memory, 2) receive a repair signature from the memory repair shadow register, 3) receive a value of 1, 4) receive a clock input, and 5) receive select inputs to channel one of the received repair signatures or the value of 1 to the memory repair register and the memory repair shadow register.

3. The method for independent repair signature load of claim 1, wherein loading the repair signature into the at least one repairable memory further comprises a Master State Machine configured to track an initial programming sequence of the repairable memory.

4. The method for independent repair signature load of claim 1, wherein determining if the power state of the at least one repairable memory transitions from a power off state to a power on state further comprises a power monitor configured for initiating a programming signal.

5. The method for independent repair signature load of claim 1, wherein loading the repair signature into the memory repair register for the at least one repairable memory from the memory repair shadow register further comprises a qualified enabling of memory input signals.

6. The method for independent repair signature load of claim 1, wherein the memory repair shadow register further comprises a duplicate memory repair register identical to the memory repair register.

7. The method for independent repair signature load of claim 1, wherein determining if the power state of the at least one repairable memory transitions from a power off state to a power on state further comprises:
writing a series of ones to the memory repair register for the at least one repairable memory; and
evaluating whether the series of ones has shifted out of the memory repair register for the at least one repairable memory.

8. The method for independent repair signature load of claim 1, wherein determining if the power state of the at least one repairable memory transitions from a power off state to a power on state further comprises a continuous process monitoring power states of each memory in the design.

9. The method for independent repair signature load of claim 1, wherein disabling a chip select for the at least one repairable memory further comprises inhibiting design selection and use of the at least one repairable memory during the loading of the repair signature.

10. The method for independent repair signature load of claim 1, wherein loading the repair signature into the memory repair register for the at least one repairable memory from the memory repair shadow register further comprises a memory repair state machine enabled to control loading of repair signatures into memory repair registers for each one of the at least one repairable memory in the design.

11. The method for independent repair signature load of claim 1, wherein loading the repair signature into the memory repair register for the at least one repairable memory from the memory repair shadow register further comprises an ordered set of states including at least one of: an IDLE state, a RESET1 state, a TEST state, a RESET2 state, a PRE-LOAD state, a LOAD state, a LAST state and a DONE state, a transition from the DONE state to the IDLE state a result of one of: a POWER transitioning from 1 to 0, and an EN2 signal transitioning to from 0 to 1, a transition from the IDLE state to the RESET1 state a result of a PROG command.

12. The method for independent repair signature load of claim 1, wherein loading the repair signature into the memory repair register for the at least one repairable memory from the memory repair shadow register further comprises a transition from the RESET1 state to the TEST state based on a number of clock cycles, a transition from the TEST state to the RESET2 state based on the a power state of the at least one repairable memory, and a transition from the RESET2 state to the PRE-LOAD state based on a number of clock cycles.

13. The method for independent repair signature load of claim 1, wherein loading the repair signature into the memory repair register for the at least one repairable memory from the memory repair shadow register further comprises a transition from the PRE-LOAD state to the LOAD state based on a number of clock cycles, a transition from the LOAD state to the LAST state based on an indication that the repair signature is loaded from the memory repair shadow register into the memory repair register for the at least one repairable memory, and a transition from the LAST state to the DONE state on completion of a reprogramming.

14. A non-transitory computer-readable medium comprising computer-executable instructions stored thereon for independent repair signature load into at least one repairable memory within a chip set of a design which, when executed by a computer device or processor, cause the computer device or processor to perform and direct the steps of:
storing a repair signature for at least one repairable memory within a memory repair register and within a memory repair shadow register, the storing occurring during an initial power on of the at least one repairable memory, the memory repair shadow register housed in an always on power domain of the design;
loading the repair signature into the at least one repairable memory from the memory repair register;
monitoring a power state of the at least one repairable memory;
determining if the power state of the at least one repairable memory transitions from a power off state to a power on state;
disabling a chip select for the at least one repairable memory if the determining results in a transition from the power off state to the power on state;
loading the repair signature into the memory repair register for the at least one repairable memory from the memory repair shadow register if the determining results in a transition from the power off state to the power on state, the loading requiring no operational halt to another of the at least one repairable memory in the design;
asserting a last signal when the repair signature from the from the memory repair shadow register has been loaded into the memory repair register for the at least one repairable memory; and
enabling the chip select for the at least one repairable memory when the last signal is asserted.

15. The non-transitory computer-readable medium of claim 14, wherein storing a repair signature for at least one repairable memory within a memory repair register and within a memory repair shadow register further comprises a design of mux selects configured to 1) receive a repair signature from a nonvolatile memory, 2) receive a repair signature from the memory repair shadow register, 3) receive a value of 1, 4) receive a clock input, and 5) receive select inputs to channel one of the received repair signatures or the value of 1 to the memory repair register and the memory repair shadow register.

16. The non-transitory computer-readable medium of claim 14, wherein loading the repair signature into the at least one repairable memory further comprises a Master State Machine configured to track an initial programming sequence of the repairable memory.

17. The non-transitory computer-readable medium of claim 14, wherein determining if the power state of the at least one repairable memory transitions from a power off state to a power on state further comprises a power monitor configured for initiating a programming signal.

18. The non-transitory computer-readable medium of claim 14, wherein loading the repair signature into the memory repair register for the at least one repairable memory from the memory repair shadow register further comprises a qualified enabling of memory input signals.

19. The non-transitory computer-readable medium of claim 14, wherein the memory repair shadow register further comprises a duplicate memory repair register identical to the memory repair register.

20. The non-transitory computer-readable medium of claim 14, wherein determining if the power state of the at least one repairable memory transitions from a power off state to a power on state further comprises:
writing a series of ones to the memory repair register for the at least one repairable memory; and
evaluating whether the series of ones has shifted out of the memory repair register for the at least one repairable memory.

21. The non-transitory computer-readable medium of claim 14, wherein determining if the power state of the at least one repairable memory transitions from a power off state to a power on state further comprises a continuous process monitoring power states of each memory in the design.

22. The non-transitory computer-readable medium of claim 14, wherein disabling a chip select for the at least one repairable memory further comprises inhibiting design selection and use of the at least one repairable memory during the loading of the repair signature.

23. The non-transitory computer-readable medium of claim 14, wherein loading the repair signature into the memory repair register for the at least one repairable memory from the memory repair shadow register further comprises a memory repair state machine enabled to control loading of repair signatures into memory repair registers for each one of the at least one repairable memory in the design.

24. The non-transitory computer-readable medium of claim 14, wherein loading the repair signature into the memory repair register for the at least one repairable memory from the memory repair shadow register further comprises an ordered set of states including at least one of: an IDLE state, a RESET1 state, a TEST state, a RESET2 state, a PRE-LOAD state, a LOAD state, a LAST state and a DONE state, a transition from the DONE state to the IDLE state based on one of: an indication a memory is powered down and an assertion of an EN2 signal for primary MRR programming, a transition from the IDLE state to the RESET1 state a result of a PROG command.

25. The non-transitory computer-readable medium of claim 14, wherein loading the repair signature into the memory repair register for the at least one repairable memory from the memory repair shadow register further comprises a transition from the RESET1 state to the TEST state based on a number of clock cycles, a transition from the TEST state to the RESET2 state based on the a power state of the at least one repairable memory, and a transition from the RESET2 state to the PRE-LOAD state based on a number of clock cycles.

26. The non-transitory computer-readable medium of claim 14, wherein loading the repair signature into the memory repair register for the at least one repairable memory from the memory repair shadow register further comprises a transition from the PRE-LOAD state to the LOAD state based on a number of clock cycles, a transition from the LOAD state to the LAST state based on an indication that the repair signature is loaded from the memory repair shadow register into the memory repair register for the at least one repairable memory, and a transition from the LAST state to the DONE state based on a number of clock cycles.
